(19) United States
(12) Patent Application Publication
(10) Pub. No.: US 2025/0028711 A1
(43) Pub. Date: Jan. 23, 2025

(54) METHODS FOR PERFORMING FULL-LINK TRACING ON TRANSACTION AND NATIVE DISTRIBUTED DATABASES

(71) Applicant: Beijing Oceanbase Technology Co., Ltd., Beijing (CN)

(72) Inventor: Zhifeng YANG, Beijing (CN)

(73) Assignee: Beijing Oceanbase Technology Co., Ltd., Beijing (CN)

(21) Appl. No.: 18/906,399

(22) Filed: Oct. 4, 2024

Related U.S. Application Data
(63) Continuation of application No. PCT/CN2023/088497, filed on Apr. 14, 2023.

(30) Foreign Application Priority Data
Apr. 21, 2022 (CN) 202210418566.0

(51) Int. Cl. G06F 16/23; G06F 16/27

(52) U.S. Cl. CPC G06F 16/2379; G06F 16/27

(57) ABSTRACT

This disclosure provides methods for performing full-link tracing on a transaction and native distributed databases. In an implementation, a method comprises determining a current execution stage of a transaction to be traced, locally recording span information corresponding to a span comprising the current execution stage, collecting span information in the execution stages comprised in the transaction after execution of the transaction is completed, and determining a full-link execution process of the transaction based on the collected span information.

### CROSS-REFERENCE TO RELATED APPLICATIONS

This application is a continuation of PCT Application No. PCT/CN2023/088497, filed on Apr. 14, 2023, which claims priority to Chinese Patent Application No. 202210418566.0, filed on Apr. 21, 2022, and each application is hereby incorporated by reference in its entirety.

### TECHNICAL FIELD

This application relates to the field of database technologies, and specifically, to methods for performing full-link tracing on a transaction and native distributed databases.

### BACKGROUND

A distributed database includes a plurality of distributed data storage nodes, and the storage nodes are independent of each other and communicatively connected to each other. In the distributed database, to execute an SQL, the storage nodes can communicate with each other by using an RPC protocol. Therefore, in the distributed database, one SQL sometimes needs to be executed by using a plurality of components such as a plurality of storage nodes. A part of operations are performed on each component, and operations performed on all the components that the SQL passes through can form a complete execution process of the SQL.

Currently, in a conventional stand-alone database, the SQL is executed on only one machine. Therefore, full-link tracing can be conveniently performed on an execution process of the SQL by recording execution time points of actions in the execution process of the SQL. However, for a distributed database, it is difficult to trace the SQL because the execution process of the SQL needs to pass through a plurality of components. In addition, due to a time difference between the components, full-link tracing cannot be performed based on time points of actions. Therefore, how to perform full-link tracing on transactions in the distributed database is an urgent problem to be solved.

### SUMMARY

In view of the above-mentioned, this application provides methods for performing full-link tracing on a transaction and native distributed databases. According to technical solutions provided in this application, full-link tracing is implemented for a transaction in a distributed database.

According to an aspect of this application, a method for performing full-link tracing on a transaction in a distributed database is provided. The transaction in the distributed database includes at least one SQL, an execution plan of each SQL includes at least one DFO, and each DFO includes at least one operator. The method includes: determining a current execution stage including a current execution action in an execution process of a transaction to be traced, where information transferred in the execution process includes a Trace ID of the transaction to be traced and Span IDs corresponding to Spans including executed execution stages included in the execution process; locally recording Span information corresponding to a Span including the current execution stage, where a semantic meaning of the Span is defined based on transaction execution logic in the distributed database, and each piece of Span information is used to determine a reference relationship between a corresponding Span and another Span in the same transaction including the corresponding Span; collecting Span information in the execution stages included in the transaction to be traced after execution of the transaction to be traced is completed; and determining a full-link execution process of the transaction to be traced based on the collected Span information.

According to another aspect of this application, a method for performing full-link tracing on a transaction in a distributed database is further provided. The method is performed by a storage node included in the distributed database, a transaction in the storage node includes at least one SQL, an execution plan of each SQL includes at least one DFO, and each DFO includes at least one operator. The method includes: determining a current execution stage including a current execution action in an execution process of a transaction to be traced in the storage node, where information transferred in the execution process includes a Trace ID of the transaction to be traced and Span IDs corresponding to Spans including executed execution stages; and locally recording Span information corresponding to a Span including the current execution stage, so that a collection device collects, from the storage node, Span information in the execution stages executed for the transaction to be traced in the storage node, and determining a full-link execution process of the transaction to be traced based on the collected Span information of the transaction to be traced, where semantic meanings of the Spans including the execution nodes are defined based on transaction execution logic in the distributed database, and each piece of Span information is used to determine a reference relationship between a corresponding Span and another Span in the same transaction including the corresponding Span.

According to another aspect of this application, a native distributed database is further provided, including a plurality of storage nodes. A transaction executed in each storage node includes at least one SQL, an execution plan of each SQL includes at least one DFO, each DFO includes at least one operator, and each storage node includes an execution stage determining unit and a Span information recording unit. The execution stage determining unit is configured to determine a current execution stage including a current execution action in an execution process of a transaction to be traced in the native distributed database, where information transferred in the execution process includes a Trace ID of the transaction to be traced and Span IDs corresponding to Spans including executed execution stages. The Span information recording unit is configured to locally record Span information corresponding to a Span including the current execution stage, so that a collection device collects, from a storage node including the Span information recording unit, Span information in the execution stages executed for the transaction to be traced in the storage node; and determine a full-link execution process of the transaction to be traced based on the collected Span information of the transaction to be traced, where semantic meanings of the Spans including the execution nodes are defined based on transaction execution logic in the distributed database, and each piece of Span information is used to determine a reference relationship between a corresponding Span and another Span in the same transaction including the corresponding Span.

According to another aspect of this application, an electronic device is further provided, including: at least one processor, a storage coupled to the at least one processor, and a computer program stored in the storage. The at least one processor executes the computer program to implement either of the above-mentioned methods for performing full-link tracing on a transaction in a distributed database.

According to another aspect of this application, a computer-readable storage medium is further provided. The computer-readable storage medium stores a computer program, and when the computer program is executed by a processor, the above-mentioned method for performing full-link tracing on a transaction in a distributed database is implemented.

According to another aspect of this application, a computer program product is further provided, including a computer program. When the computer program is executed by a processor, either of the above-mentioned methods for performing full-link tracing on a transaction in a distributed database is implemented.

### BRIEF DESCRIPTION OF DRAWINGS

The essence and advantages of the embodiment content of this application can be further understood by referring to the following accompanying drawings. In the accompanying drawings, similar components or features can have the same reference numerals.

FIG. 1 is a schematic diagram illustrating an example of a distributed database;

FIG. 2 is a schematic diagram illustrating an example of interaction between a OceanBase database and an application;

FIG. 3 is a flowchart illustrating an example of a method for performing full-link tracing on a transaction in a distributed database, according to some embodiments of this application;

FIG. 4 is a schematic diagram illustrating an example of a tree structure corresponding to an SQL execution plan;

FIG. 5 is a schematic diagram illustrating an example displaying a full-link execution process of a transaction according to some embodiments of this application;

FIG. 6 is a flowchart illustrating an example of a method for performing full-link tracing on a transaction in a distributed database, according to some embodiments of this application;

FIG. 7 is a block diagram illustrating an example of a native distributed database, according to some embodiments of this application; and

FIG. 8 is a block diagram illustrating an electronic device configured to implement a method for performing full-link tracing on a transaction, according to some embodiments of this application.

### DESCRIPTION OF EMBODIMENTS

The subject matter described here will be discussed below with reference to example implementations. It should be understood that these implementations are merely discussed to enable a person skilled in the art to better understand and implement the subject matter described in this specification, and are not intended to limit the protection scope, applicability, or examples described in the claims. Functions and arrangements of elements under discussion can be changed without departing from the protection scope of embodiment content of this application. In the examples, various processes or components can be omitted, replaced, or added as needed. In addition, features described for some examples can also be combined in other examples.

As used in this specification, the term “include” and its variant represent open terms, meaning “including but not limited to”. The term “based on” represents “at least partially based on”. The terms “one embodiment” and “an embodiment” represent “at least one embodiment”. The term “another embodiment” represents “at least one other embodiment”. The terms “first”, “second”, etc. can refer to different or the same objects. Other definitions, whether explicit or implicit, can be included below. Unless explicitly stated in the context, the definition of a term is consistent throughout this specification.

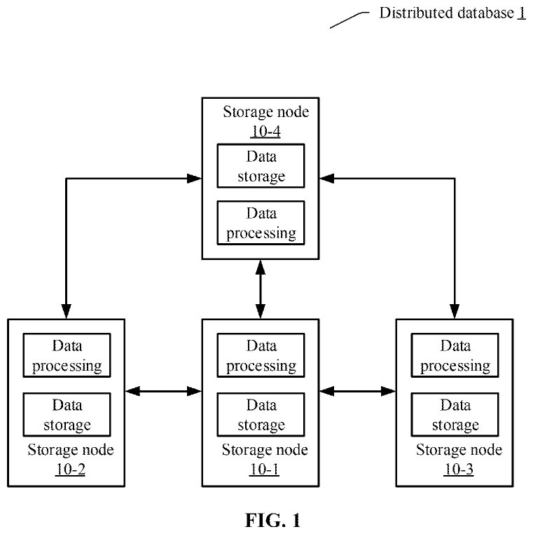

FIG. 1 is a schematic diagram illustrating an example of distributed database 1.

As shown in FIG. 1, distributed database 1 can include a plurality of storage nodes 10-1 to 10-4. The storage nodes 10-1 to 10-4 are distributed storage nodes, and each storage node can independently perform data processing and data storage. It is worthwhile to note that the example shown in FIG. 1 is merely an example. In other embodiments, distributed database 1 can include more or fewer storage nodes.

For example, distributed database 1 can use a share nothing architecture, for example, a OceanBase database. In this distributed database, data are stored in the storage nodes in a distributed way. For example, the data can be partitioned into a plurality of data partitions (also referred to as data blocks), and the data partitions obtained through partitioning are respectively stored in different storage nodes. Each storage node can store one or more data partitions. CPU resources and IO resources needed for data access in each storage node are locally performed by the storage node.

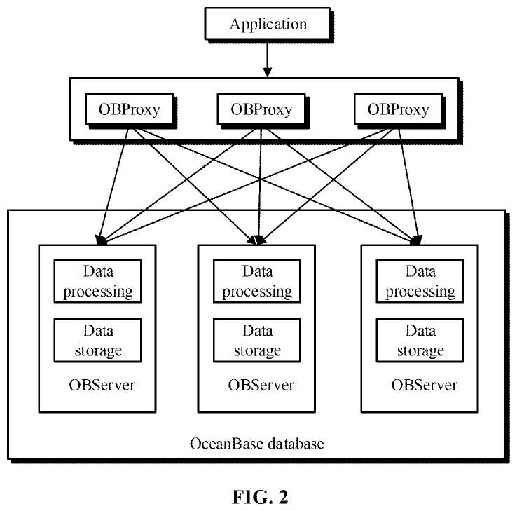

FIG. 2 is a schematic diagram illustrating an example of interaction between a OceanBase database and an application.

As shown in FIG. 2, the OceanBase database can include a plurality of OBServers, and each OBServer is equivalent to one storage node and is configured to provide data storage and data processing. The OBServers included in the OceanBase database can communicate with each other by using an RPC protocol. It is worthwhile to note that the three OBServers in FIG. 2 are merely used as examples. In other embodiments, more or fewer OBServers can be included.

The application can access the OceanBase database by using an OBProxy (OceanBase Database Proxy, ODP). The OBProxy is a stateless proxy server, and the OceanBase database can be communicatively connected to a plurality of OBProxies. It is worthwhile to note that the three OBProxies in FIG. 2 are merely used as examples. In other embodiments, more or fewer OBProxies can be deployed.

The OBProxy is connected to both the application and the OceanBase database. The OBProxy is configured to receive an SQL request sent by the application, forward the SQL request to a target OBServer, and feed back an execution result to the application. There is no connection between the OBProxies, and a load balancing cluster can be formed by using F5/SLB. The OBProxies can be deployed on the same physical machine with the OBServer, or can be deployed on an application server.

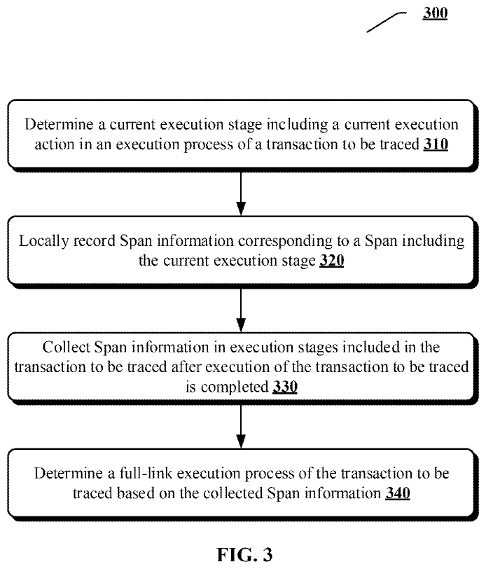

FIG. 3 is a flowchart illustrating an example 300 of a method for performing full-link tracing on a transaction in a distributed database, according to some embodiments of this application.

In this application, a transaction includes all operations performed between a start of the transaction and an end of the transaction. The transaction in the distributed database needs to be executed by using the distributed database. In one example, most of the operations included in the transaction in the distributed database are executed in the distributed database. For example, an application initiates an SQL request, and the distributed database executes the SQL.

The transaction in the distributed database can be an atomic execution unit including a series of SQLs, that is, the transaction in the distributed database includes at least one SQL. The at least one SQL forming one transaction can be executed in sequence to form a complete execution logic process.

Execution of each SQL can be equivalent to a physical execution plan, and the SQL can be executed based on a corresponding execution plan. The execution plan of each SQL can include at least one DFO (data flow object), where the DFO is a segment of the execution plan of the SQL and can be invoked individually for execution. The execution plan of the SQL can be equivalent to a DAG (Directed Acyclic Graph) including a plurality of sub-plans, and each sub-plan is one DFO.

Each DFO serving as the sub-plan can include at least one operator, and an operation type corresponding to an operation performed by each operator is determinate. The operator is a basic component unit that forms the DFO, and therefore is also a basic component unit that forms the SQL execution plan. The execution plan of each SQL can be a state tree including a plurality of operators, and each operator in the state tree can be used to describe a basic operation corresponding to a specific semantic meaning of the SQL. For example, the operators include a TABLE SCAN operator, an EXCHANGE operator, a JOIN operator, a TABLE DELETE operator, and a GROUP BY operator.

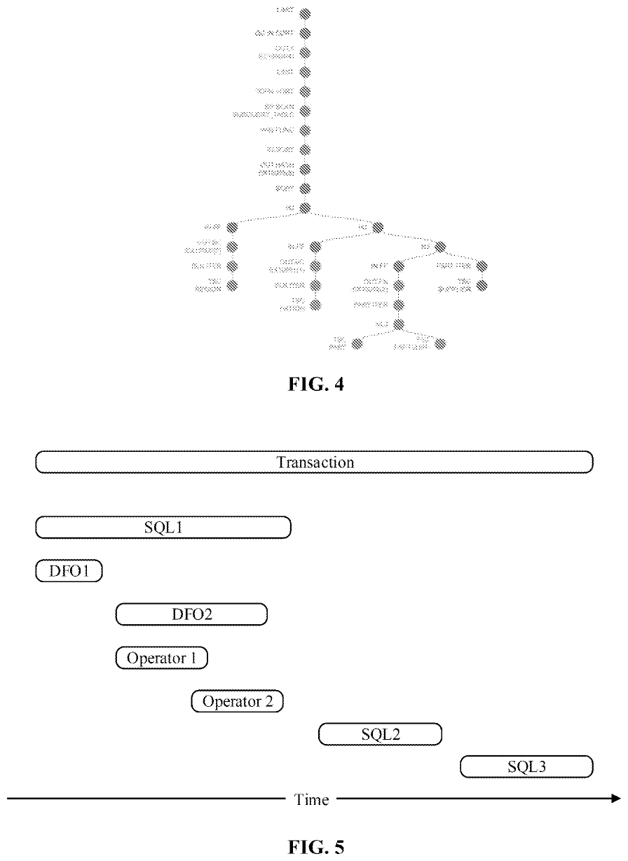

FIG. 4 is a schematic diagram illustrating an example of a state tree corresponding to an SQL execution plan. As shown in FIG. 4, each circle in the state tree represents an operator. A plurality of consecutive operators can form one sub-plan, that is, form one DFO. For example, the first operator (LIMIT) and the second operator (OC IN SORT) can form one DFO, and the third operator (OUT.1:EX10004 (4)) to the eighth operator (IN.SORT) can form another DFO. The state tree formed by all the operators shown in FIG. 4 is the execution plan of the SQL.

In an example, the distributed database targeted by this application can include a native distributed database. Further, the native distributed database targeted by this application can include a OceanBase database.

As shown in FIG. 3, at 310, a current execution stage including a current execution action can be determined in an execution process of a transaction to be traced.

In this application, a plurality of transactions can be performed in parallel in the distributed database. In an example, each transaction executed in the distributed database can be determined as a transaction to be traced. In another example, some transactions in the distributed database can be determined as transactions to be traced, and only some transactions in the distributed database can be traced.

In a way of determining the transaction to be traced, each transaction to be executed in the distributed database can be sampled, and then a sampled transaction is determined as the transaction to be traced.

In a sampling way, a second specified quantity of transactions can be sampled from a first specified quantity of transactions to be executed per batch, where the second specified quantity is less than the first specified quantity, and transactions to be executed included in batches are different. For example, one transaction can be sampled from the first specified quantity of transactions to be executed per batch. In another sampling way, sampling can be performed based on time. In an example, sampling can be performed at intervals of specified duration, and a quantity of transactions sampled each time can be a third specified quantity. In another example, a fourth specified quantity of times of sampling can be performed in each time period, and a quantity of transactions sampled each time can be a fifth specified quantity. In another sampling way, sampling can be performed randomly.

In this application, each execution stage in a transaction execution process can be a continuous process, and each execution stage can include a plurality of execution actions. The plurality of execution actions are sequentially executed to form a set of execution logic, and the formed execution logic is execution logic of an execution stage including the execution actions. The plurality of execution actions included in the same execution stage can include a start execution action and an end execution action. The start execution action can represent a start of the execution stage including the execution actions, and the end execution action can represent an end of the execution stage including the execution actions. For example, an execution process of each SQL can be used as a complete execution stage, and execution stages of each SQL can include a parsing stage, an optimization stage, a specific execution stage, etc. An execution process of each DFO can be used as an execution stage, and an execution process of each operator can also be used as an execution stage.

For each transaction, a Trace ID can be generated while the transaction is initiated, and the Trace ID can be used to identify a full-link tracing process of the transaction. In a complete execution process of the transaction, an entire call chain of a request always carries the Trace ID, and an upstream service carries the Trace ID for transmission to a downstream service. Therefore, a complete execution path of the transaction can be marked by using the Trace ID.

In addition, in the execution process of the transaction to be traced, transferred information can further include Span IDs corresponding to Spans including executed execution stages.

In this application, the Span represents a logical unit that has start time and execution duration, and a logical causal relationship can be established between the Spans through nesting or sequential arrangement. Each Span has a semantic meaning, and the semantic meaning of the Span can be defined based on transaction execution logic in the distributed database. For example, transaction execution logic of a transaction can be represented by using an SQL, a DFO, an operator, etc. In this case, the semantic meaning of the Span can be defined based on the SQL, the DFO, the operator, etc.., for example, a Span of an SQL type, a Span of a DFO type, and a Span of an operator type.

The semantic meaning of each Span determines a type of the Span. Different types of Spans can have different semantic meanings, and can have different functions. Each type of Span can be standardized, and the standardized Span can be directly applied to an application scenario of the distributed database.

In way of standardizing the Span, an operation name of the Span and a Span Tag corresponding to the Span can be standardized. The Span Tag can be a set that forms the Span tag, and can be used to represent an attribute of the Span. The operation name and the Span Tag of each Span can be used to represent the semantic meaning of the Span. After the operation name and the Span Tag of the Span are determined, the semantic meaning of the Span is also determined.

In this application, corresponding Spans can be set for execution stages included in the transaction execution process, and Spans with different semantic meanings can be set for different execution stages. The semantic meaning of the Span corresponding to each execution stage is determined based on a location of the execution stage in the transaction execution logic. For example, for an execution stage of one DFO included in an SQL, it can be set that the Span corresponding to the execution stage is the Span for the DFO, and a process represented by the Span is an execution process of the DFO.

Each Span has a corresponding Span ID, and the Span IDs are in a one-to-one mapping relationship with the Spans. The Span ID corresponding to each Span is generated in the execution stage of the Span and is used to identify an internal call state of the execution stage. After each execution stage is completed, the Span ID of the execution stage is transferred to a downstream execution stage together with the Trace ID. Therefore, a complete execution process of the transaction to be traced can be determined by using the Trace ID and the Span IDs corresponding to the execution stages.

In this application, it is determined that an execution body of the current execution stage can be an execution device configured to execute the current execution stage. When the transaction to be traced needs to be executed by using a plurality of devices, it is determined that the execution body of the current execution stage can vary in different execution stages.

In an example, the transaction to be traced is executed by using the distributed database, and therefore the current execution stage can be determined by the distributed database. For example, an application is communicatively connected to the distributed database, and the transaction to be traced can be initiated by the application and executed in the distributed database, so that the distributed database performs an operation of determining the current execution stage.

In another example, the distributed database can be communicatively connected to a proxy server, and the proxy server is configured to forward a transaction request initiated by a driver deployed in a client device to the distributed database, so that an execution process of each transaction can respectively pass through the driver, the proxy server, and the distributed database. For example, when the distributed database is a OceanBase database, the proxy server can be an OBProxy.

In this example, the transaction to be traced can be initiated by the driver deployed in the client device and specifically executed in the proxy server and the distributed database. In this case, when the current execution stage is in the proxy server, an execution body configured to perform the operation of determining the current execution stage can be the proxy server; or when the current execution stage is in the distributed database, an execution body configured to perform the operation of determining the current execution stage can be the distributed database.

Back to FIG. 3, at 320, Span information corresponding to a Span including the current execution stage can be recorded locally.

In this application, corresponding Span information can be generated after execution in the execution stage corresponding to each Span is completed. Each piece of Span information can be used to determine a reference relationship between a corresponding Span and another Span in the same transaction including the corresponding Span. The reference relationship can include a parent-child relationship (Child_Of), a follow relationship (Follows_From), etc.

The parent-child relationship means that an execution stage of another Span occurs in an execution stage of one Span. For example, in a transaction request, a Span generated by a called party and a Span generated by a party initiating a call can form a parent-child relationship. For another example, a Span of an SQL Insert operation and a Span of a Insert Row method of a database storage engine form a parent-child relationship.

The follow relationship means that an execution stage of another Span occurs after an execution stage of one Span, and is used to describe a sequential execution relationship. In the follow relationship, an execution stage corresponding to a preferentially executed Span does not depend on an execution result generated in an execution stage corresponding to a later executed Span.

In an example, each Span correspondingly includes a plurality of types of state information: an operation name, start time (Start Timestamp), end time (End Timestamp), a Span Tag, Span Logs, SpanContext, References, etc. The Span Logs can be a set of Span logs. The SpanContext can include global context information for performing full-link tracing. For example, the SpanContext can include a Trace ID and Span IDs corresponding to Spans. The References is used to represent a reference relationship between Spans, and the reference relationship represented by the References can include a parent-child relationship, a follow relationship, etc.

Corresponding Span information can be obtained based on the state information of the Span, that is, the Span information of each Span can include the operation name, the start time, the end time, the Span Tag, the Span Logs, the SpanContext, the References, etc. of the Span. The state information included in the Span information corresponding to different Spans can be different. For example, the Span for the SQL is different from the Span for the DFO in terms of operation name, start time, end time, etc. in the Span information.

An execution sequence of execution stages corresponding to the Spans can be determined by using the reference relationship between the Spans, so that a full-link execution process of a transaction can be determined.

In this application, an execution body that records the Span information is an execution device in the current execution stage. For example, when the execution device in the current execution stage is the OBProxy, the OBProxy records the Span information; or when the execution device in the current execution stage is the distributed database, the distributed database records the Span information. In an example, each storage node in the distributed database can serve as an execution body for independently performing an operation. When the execution device in the current execution stage is a storage node in the distributed database, the storage node serves as the execution body to record the Span information.

The Span information can be recorded in a local log file in a form of a log. For example, in the OBProxy, the Span information can be recorded in OBProxy.log, and in each OBServer included in the OceanBase database, the Span information can be recorded in OBServer.log.

The execution body in the current execution stage can buffer, in context of each session, Span information corresponding to a plurality of Spans for the transaction to be traced. For example, when one SQL includes a plurality of DFOs and each DFO includes a plurality of operators, Span information of the SQL can be buffered in the context of the session when the SQL starts to be executed. When one DFO included in the SQL starts to be executed, both the Span information of the SQL and Span information of the DFO can be buffered in the context. When one operator included in the DFO starts to be executed, the Span information of the SQL, the Span information of the DFO, and Span information of the operator all can be buffered in the context.

When each execution stage is completed, the Span information in the execution stage can be recorded locally, and buffered content in the context of the session is updated. For example, when execution of the operator is completed, the Span information of the operator can be recorded locally, and the Span information of the operator buffered in the context of the session is deleted. When execution of the DFO is completed, the Span information of the DFO can be recorded locally, and the Span information of the DFO buffered in the context of the session is deleted. When execution of the SQL is completed, the Span information of the SQL can be recorded locally, and the Span information of the SQL buffered in the context of the session is deleted.

The Span information is recorded locally, to avoid transferring the Span information during a remote call after the Span information is obtained in each execution stage, thereby reducing resource overheads in the transaction execution process and improving transaction execution efficiency while saving resources.

In an example, each execution stage included in a transaction can have an execution granularity attribute, and execution granularities can be divided based on transaction execution logic. In a granularity division method, transaction execution logic of a transaction can be represented by using an SQL, a DFO, an operator, etc. In this case, an execution granularity of the transaction can be represented by using the SQL, the DFO, the operator, etc. For example, the SQL, the DFO, and the operator each can represent an execution granularity, that is, execution granularities obtained through division can include an SQL granularity, a DFO granularity, and an operator granularity.

Granularity sizes of different execution granularities can be different. In the transaction execution logic, when an execution stage includes a sub-execution stage, an execution granularity corresponding to the execution stage is greater than an execution granularity corresponding to the sub-execution stage. For example, the SQL granularity is greater than the DFO granularity, and the DFO granularity is greater than the operator granularity.

When each execution stage has an execution granularity attribute, a Span including the execution stage can also correspond to an execution granularity, and the execution granularity corresponding to each Span is an execution granularity attribute of the Span. When an execution process of a transaction is determinate, execution logic of each execution stage included in the transaction can be determined. Correspondingly, a Span corresponding to each execution stage can be determined, and an execution granularity attribute of each execution stage can be determined, so that an execution granularity attribute of the Span corresponding to each execution stage can be determined.

When the current execution stage is determined, an execution granularity corresponding to the current execution stage can be determined. Then, it can be determined whether the execution granularity corresponding to the current execution stage is greater than a specified execution granularity threshold, and the specified execution granularity threshold the be any execution granularity in execution granularities for the transaction.

When the execution granularity corresponding to the current execution stage is greater than the execution granularity threshold, the Span information corresponding to the Span including the current execution stage can be recorded locally. When the execution granularity corresponding to the current execution stage is not greater than the execution granularity threshold, the Span information of the current execution stage may not be recorded.

For execution granularities of execution stages, Span information of a part of execution stages can be specifically recorded based on the execution granularity threshold, and it is unnecessary to record Span information of all the execution stages included in a transaction, to avoid generation of a large quantity of data used for full-link tracing, thereby reducing impact caused on performance of the distributed database by generated full-link tracing data, and reducing a quantity of data processed when the Span information is processed subsequently.

At 330, Span information in the execution stages included in the transaction to be traced can be collected after execution of the transaction to be traced is completed.

In an example, a collection device outside the distributed database can be used to collect the Span information in the execution stages included in the transaction to be traced. The collection device can be connected to devices that the transaction to be traced passes through, to collect the Span information of the transaction to be traced from the devices.

For example, when the transaction to be traced is executed by using the OBProxy and the distributed database, the Span information is respectively stored in the OBProxy and the distributed database, and the collection device can respectively collect the Span information of the transaction to be traced from the OBProxy and the distributed database.

In an example, each storage node in the distributed database can run independently, so that each storage node can locally store Span information corresponding to an executed execution stage. Therefore, when the collection device is connected to the distributed database, the collection device can be connected to the storage nodes in the distributed database, so that the collection device can collect the stored Span information from the storage nodes.

In an example, the collection device can be a device that matches the distributed database, and the collection device can identify various semantic meanings in the distributed database, for example, the SQL, the DFO, and the operator in the distributed database. In this example, the collection device can include a collection unit, a storage unit, and a display unit. The collection unit sends the collected Span information to the storage unit for storage, and the display unit can display a full-link execution process of the transaction based on the Span information obtained from the storage unit. For example, the collection unit can be an ob_trace_agent, the storage unit can be an OCP database, and the display unit can be an OCP UI.

In another example, the collection device can be a general-purpose collection device, and the general-purpose collection device can identify a semantic meaning of generic code, and can be applied to various application scenarios for data collection. For example, a collection unit in the general-purpose collection device can be a Jaeger Agent or a Jaeger Collector, a storage unit in the general-purpose collection device can be a Jaeger DB, and a display unit in the general-purpose collection device can be a Jaeger UI.

At 340, a full-link execution process of the transaction to be traced can be determined based on the collected Span information.

In this application, a reference relationship and an execution sequence relationship between the Spans can be determined based on a reference relationship that is represented by each piece of Span information and that is between a corresponding Span and another Span in the same transaction including the corresponding Span. Then, an execution sequence of the execution stages can be correspondingly determined based on the reference relationship and the execution sequence relationship between the Spans, and the execution stages can form the full-link execution process of the transaction to be traced in the execution sequence.

In an example, the execution stages corresponding to the Span information can be arranged in a time dimension based on the reference relationship between the Spans determined by the Span information, to display the full-link execution process of the transaction to be traced.

In this example, an execution time period of a corresponding execution stage can be determined based on start time and end time in each piece of Span information. When two Spans are in a parent-child relationship, an execution time period corresponding to a child Span is included in an execution time period corresponding to a parent Span, that is, start time of the child Span is later than start time of the parent Span, and end time of the child Span is earlier than end time of the parent Span. When two Spans are in a follow relationship, an execution time period of an upstream Span is before an execution time period of the downstream Span.

Each execution stage can be represented by a time bar. Each time bar can be determined by start time, end time, and duration. When the execution stages are arranged in the time dimension, a time bar corresponding to an execution stage that is executed first is arranged before a time bar corresponding to an execution stage executed later. For two execution stages corresponding to two Spans in a parent-child relationship, a time bar corresponding to an execution stage of a child Span is included in a time bar corresponding to an execution stage of a parent Span.

FIG. 5 is a schematic diagram illustrating an example displaying a full-link execution process of a transaction according to some embodiments of this application. As shown in FIG. 5, the transaction includes three SQLs: SQL1, SQL2, and SQL3, and SQL1, SQL2, and SQL3 are in a follow relationship. SQL1 includes DFO1 and DFO2. SQL1 is in a parent-child relationship with both DFO1 and DFO2, and DFO1 and DFO2 are in a follow relationship. DFO2 includes operator 1 and operator 2. DFO2 is in a parent-child relationship with both operator 1 and operator 2, and operator 1 and operator 2 are in a follow relationship. The full-link execution process of the transaction including SQL1, SQL2, SQL3, DFO1, DFO2, operator 1, and operator 2 is shown in FIG. 5.

The full-link execution process of the transaction is displayed, so that time consumed in each execution stage of the transaction and a time interval between adjacent execution stages of the transaction can be clearly learned. Therefore, a transaction execution process and problems such as time-consuming existing in the execution process can be analyzed based on the displayed full-link execution process. For the time-consuming problem, a cause of the time-consuming problem in transaction execution can be identified based on the time consumed in each execution stage, so that a problematic execution stage can be specifically optimized, thereby improving overall transaction execution efficiency.

In an example, a distributed database can communicate with a proxy server, and the proxy server can further communicate with a client device. For example, an external network structure of the distributed database can be shown in FIG. 2. In this example, each transaction to be executed can be initiated by a driver deployed in the client device, so that an execution process of each transaction can respectively pass through the driver deployed in the client device, the proxy server, and the distributed database.

When initiating a transaction to be executed, the driver can generate a corresponding Trace ID for the transaction to be executed. In a subsequent execution process of the transaction to be executed, the Trace ID is always transferred following the execution process. After initiating the transaction to be executed, the driver can perform a corresponding operation in an execution stage to generate corresponding Span information, where the Span information can include the Trace ID. The driver can send locally obtained Span information to the proxy server, and the proxy server records the Span information received from the driver in the proxy server.

In this example, the driver does not locally record the locally generated Span information, but records the locally generated Span information in the proxy server. As such, in a stage of collection of the Span information, the Span information in the client device can be collected from the proxy server, to avoid invading an application in the client device to collect the Span information in the client device.

In an example, the driver can send the locally generated Span information to the proxy server in a piggyback way. In this example, after generating the Span information, the driver can determine a piece of information from other information that the driver needs to send to the proxy server, and add the Span information to an additional field of the determined information. When the driver sends the information to the proxy server, the Span information is sent to the proxy server accordingly. The determined information is information that is inevitably sent by the driver to the proxy server, for example, transaction request information sent by the driver to the proxy server. For example, after generating the Span information, the driver can determine that a next piece of information to be sent by the driver to the proxy server is information that includes the Span information.

In this example, the driver sends the Span information to the proxy server in a piggyback way without individually sending the Span information to the proxy server, to avoid occupying resources of the client device.

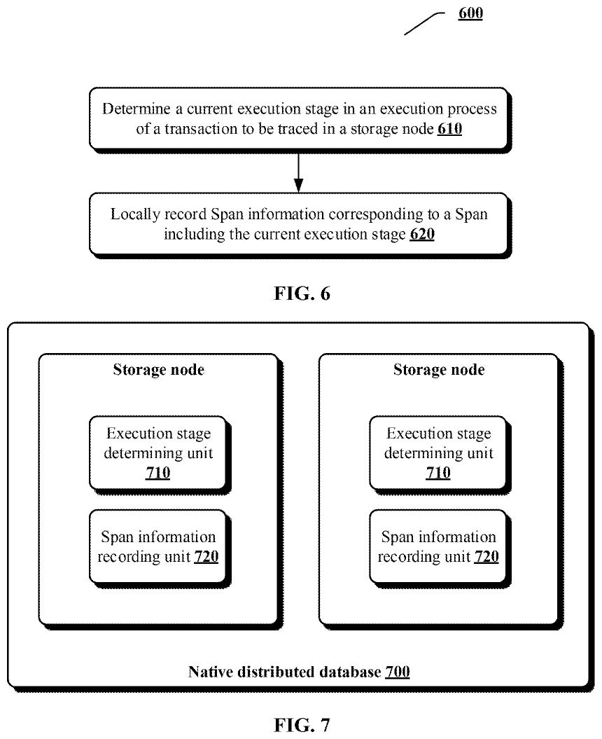

FIG. 6 is a flowchart illustrating an example 600 of a method for performing full-link tracing on a transaction in a distributed database, according to some embodiments of this application.

The method shown in FIG. 6 can be performed by a storage node included in the distributed database. A transaction in the storage node includes at least one SQL, an execution plan of each SQL includes at least one DFO, and each DFO includes at least one operator. In an example, the distributed database can be a native distributed database.

As shown in FIG. 6, at 610, a current execution stage including a current execution action is determined in an execution process of a transaction to be traced in the storage node.

Information transferred in the execution process includes a Trace ID of the transaction to be traced and Span IDs corresponding to Spans including executed execution stages, and the executed execution stages include an execution stage executed in the storage node and execution stages executed in another storage node and a device.

At 620, Span information corresponding to a Span including the current execution stage is stored locally, so that a collection device collects, from the storage node, Span information in the execution stages executed for the transaction to be traced in the storage node, and a full-link execution process of the transaction to be traced is determined based on the collected Span information of the transaction to be traced, where semantic meanings of the Spans including the execution nodes are defined based on transaction execution logic in the distributed database, and each piece of Span information is used to determine a reference relationship between a corresponding Span and another Span in the same transaction including the corresponding Span.

In an example, that the Span information corresponding to a Span including the current execution stage is stored locally includes: When an execution granularity corresponding to the current execution stage is greater than an execution granularity threshold, the Span information corresponding to the Span including the current execution stage is stored locally, where execution granularities are divided based on the transaction execution logic, and the Span including each execution stage corresponds to one execution granularity.

FIG. 7 is a block diagram illustrating an example 700 of a native distributed database, according to some embodiments of this application.

The native distributed database shown in FIG. 7 includes a plurality of storage nodes. A transaction executed in each storage node includes at least one SQL, an execution plan of each SQL includes at least one DFO, and each DFO includes at least one operator. Each storage node includes an execution stage determining unit 710 and a Span information recording unit 720. It is worthwhile to not that, the native distributed database shown in FIG. 7 including two storage nodes is merely used as an example. In another embodiment, the native distributed database can include more or fewer storage nodes.

The execution stage determining unit 710 can be configured to determine a current execution stage including a current execution action in an execution process of a transaction to be traced in the native distributed database, where information transferred in the execution process includes a Trace ID of the transaction to be traced and Span IDs corresponding to Spans including executed execution stages.

The Span information recording unit 720 can be configured to locally record Span information corresponding to a Span including the current execution stage, so that a collection device collects, from a storage node including the Span information recording unit, Span information in the execution stages executed for the transaction to be traced in the storage node; and determine a full-link execution process of the transaction to be traced based on the collected Span information of the transaction to be traced, where semantic meanings of the Spans including the execution nodes are defined based on transaction execution logic in the distributed database, and each piece of Span information is used to determine a reference relationship between a corresponding Span and another Span in the same transaction including the corresponding Span.

In an example, the Span information recording unit 720 can be further configured to locally record the Span information corresponding to the Span including the current execution stage when an execution granularity corresponding to the current execution stage is greater than an execution granularity threshold, where execution granularities are divided based on the transaction execution logic, and the Span including each execution stage corresponds to one execution granularity.

Embodiments of the method and the apparatus for performing full-link tracing on a transaction in a distributed database according to the embodiments of this application are described above with reference to FIG. 1 to FIG. 7.

The apparatus for performing full-link tracing on a transaction in a distributed database in this application can be implemented by hardware, or can be implemented by software or a combination of hardware and software. Software implementation is used as an example. As a logical apparatus, the apparatus is formed by reading corresponding computer program instructions in a storage to a memory by a processor of a device where the device is located. In this application, the apparatus for performing full-link tracing on a transaction in a distributed database can be implemented by, for example, an electronic device.

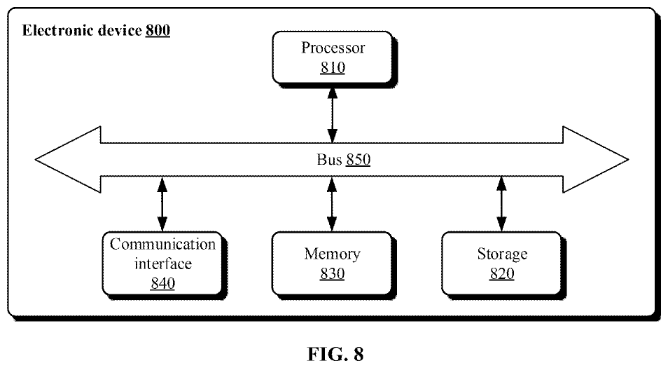

FIG. 8 is a block diagram illustrating an electronic device 800 configured to implement a method for performing full-link tracing on a transaction, according to some embodiments of this application.

As shown in FIG. 8, the electronic device 800 can include at least one processor 810, a storage (for example, a non-volatile memory) 820, a memory 830, and a communication interface 840, and the at least one processor 810, the storage 820, the memory 830, and the communication interface 840 are connected together by using a bus 850. The at least one processor 810 executes at least one computer-readable instruction (namely, the above-mentioned elements implemented in a software form) stored or encoded in the storage.

In some embodiments, the storage stores computer-executable instructions, and when the computer-executable instructions are executed, at least one processor 810 determines a current execution stage including a current execution action in an execution process of a transaction to be traced in a storage node; and locally record Span information corresponding to a Span including the current execution stage, so that a collection device collects, from the storage node, Span information in the execution stages executed for the transaction to be traced in the storage node, and determine a full-link execution process of the transaction to be traced based on the collected Span information of the transaction to be traced, where semantic meanings of the Spans including the execution nodes are defined based on transaction execution logic in a distributed database, and each piece of Span information is used to determine a reference relationship between a corresponding Span and another Span in the same transaction including the corresponding Span.

It should be understood that, when the computer-executable instructions stored in the storage are executed, the at least one processor 810 performs the above-mentioned operations and functions described with reference to FIG. 1 to FIG. 7 in the embodiments of this specification.

According to some embodiments, a program product such as a machine-readable medium is provided. The machine-readable medium can have instructions (namely, the above-mentioned elements implemented in software form). When the instructions are executed by a machine, the machine performs the above-mentioned operations and functions described with reference to FIG. 1 to FIG. 7 in the embodiments of this specification.

Specifically, a system or an apparatus equipped with a readable storage medium can be provided, and software program code for implementing a function of any one of the above-mentioned embodiments is stored in the readable storage medium, so that a computer or a processor of the system or apparatus reads and executes instructions stored in the readable storage medium.

In this case, the program code read from the readable medium can implement the function in any one of the above-mentioned embodiments. Therefore, the machine-readable code and the readable storage medium that stores the machine-readable code form a part of this application.

Computer program code needed for operation of each part of this specification can be compiled in any one or more programming languages, including an object-oriented programming language such as Java, Scala, Smalltalk, Eiffel, JADE, Emerald, C++, C#, VB, NET, and Python, a conventional programming language such as a C language, Visual Basic 2003, Perl, COBOL 2002, PHP, and ABAP, a dynamic programming language such as Python, Ruby, and Groovy, or another programming language. The program code can run on a user computer, or run as a stand-alone software package on the user computer, or partially run on the user computer and partially run on a remote computer, or completely run on the remote computer or a server. In the latter case, the remote computer can be connected to the user computer in any form of network, such as a local area network (LAN) or a wide area network (WAN), or connected to an external computer (for example, via the Internet), or in a cloud computing environment, or used as a service, such as software as a service (SaaS).

Embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, a DVD-RW), a magnetic tape, a non-volatile memory card, and a ROM. Alternatively, the program code can be downloaded from a server computer or a cloud by a communication network.

Specific embodiments of this specification are described above. Other embodiments fall within the scope of the appended claims. In some cases, the actions or steps described in the claims can be performed in an order different from that in the embodiments, and the desired results can still be achieved. In addition, processes depicted in the accompanying drawings do not necessarily need a specific order or a sequential order shown to achieve the desired results. In some implementations, multi-tasking and concurrent processing are feasible or can be advantageous.

Not all steps and units in the above-mentioned procedures and system structure diagrams are necessary. Some steps or units can be ignored based on actual needs. An execution order of the steps is not fixed, and can be determined based on a need. The apparatus structure described in the above-mentioned embodiments can be a physical structure, or can be a logical structure. In other words, some units can be implemented by the same physical entity, or some units can be implemented by a plurality of physical entities or implemented jointly by some components in a plurality of independent devices.

The term “example” used throughout this specification means “used as an example, an instance, or an illustration” and does not mean “preferred” or “advantageous” over other embodiments. For the purpose of providing an understanding of the described technologies, specific implementations include specific details. However, these technologies can be implemented without these specific details. In some instances, to avoid obscuring the described concepts in the embodiments, well-known structures and apparatuses are shown in a form of a block diagram.

Optional implementations of the embodiments of this specification are described above in detail with reference to the accompanying drawings. However, the embodiments of this specification are not limited to specific details in the above-mentioned implementations. Within a technical concept scope of the embodiments of this specification, a plurality of simple variations can be made to the technical solutions in the embodiments of this specification, and these simple variations all fall within the protection scope of the embodiments of this specification.

The above-mentioned descriptions of the content in this specification are provided to enable any person of ordinary skill in the art to implement or use the content in this specification. It is obvious to a person of ordinary skill in the art that various modifications can be made to the content in this specification. In addition, the general principle defined in this specification can be applied to another variant without departing from the protection scope of the in this specification. Therefore, the content in this specification is not limited to the examples and designs described here, but is consistent with the widest range of principles and novelty features that conform to this disclosure.

1. A computer-implemented method for performing full-link tracing on a transaction in a distributed database comprising:
determining a current execution stage of a transaction to be traced, wherein the current execution stage comprises a current execution action in an execution process, wherein information transferred in the execution process comprises a trace ID of the transaction and span IDs, and wherein the span IDs correspond to spans of execution stages comprised in the execution process;
locally recording span information corresponding to a span comprising the current execution stage, wherein the span has a semantic meaning determined based on a transaction execution logic in the distributed database, and each piece of span information determines a reference relationship between a corresponding span and another span in the same transaction comprising the corresponding span;
collecting span information in the execution stages comprised in the transaction after execution of the transaction is completed; and
determining a full-link execution process of the transaction based on the collected span information.

2. The computer-implemented method according to claim 1, wherein the locally recording span information corresponding to a span comprising the current execution stage comprises:
locally recording the span information corresponding to the span comprising the current execution stage when an execution granularity corresponding to the current execution stage is greater than an execution granularity threshold, wherein execution granularities are divided based on the transaction execution logic, and the span comprising each execution stage corresponds to one execution granularity.

3. The computer-implemented method according to claim 2, wherein the transaction comprises at least one structured query language (SQL), an execution plan of each SQL comprises at least one data flow object (DFO), and each DFO comprises at least one operation, and wherein execution granularities obtained through division comprise an SQL granularity, a DFO granularity, and an operator granularity.

4. The computer-implemented method according to claim 1, further comprising:
sampling each transaction to be executed in the distributed database; and
determining the sampled transaction as the transaction to be traced.

5. The computer-implemented method according to claim 1, wherein the determining a full-link execution process of the transaction based on the collected span information comprises:
arranging, in a time dimension based on a reference relationship between spans determined by the collected span information, execution stages corresponding to the span information to display the full-link execution process of the transaction.

6. The computer-implemented method according to claim 1, wherein the distributed database is communicatively connected to a proxy server, the proxy server is configured to forward a transaction request initiated by a driver deployed in a client device to the distributed database, and an execution process of each transaction respectively passes through the driver, the proxy server, and the distributed database.

7. The computer-implemented method according to claim 6, further comprising:
generating, at the driver, a corresponding trace ID for the transaction to be executed; and
sending, at the driver, locally generated span information comprising the trace ID to the proxy server, so that the proxy server records the span information in the proxy server.

8. The computer-implemented method according to claim 7, wherein the sending, at the driver, locally generated span information comprising the trace ID to the proxy server comprises:
sending, at the driver, the locally generated span information comprising the trace ID to the proxy server in a piggyback way.

9. A non-transitory, computer-readable medium storing one or more instructions executable by a computer system to perform operations for performing full-link tracing on a transaction in a distributed database, the operations comprising:
determining a current execution stage of a transaction to be traced, wherein the current execution stage comprises a current execution action in an execution process, wherein information transferred in the execution process comprises a trace ID of the transaction and span IDs, and wherein the span IDs correspond to spans of execution stages comprised in the execution process;
locally recording span information corresponding to a span comprising the current execution stage, wherein the span has a semantic meaning determined based on a transaction execution logic in the distributed database, and each piece of span information determines a reference relationship between a corresponding span and another span in the same transaction comprising the corresponding span;
collecting span information in the execution stages comprised in the transaction after execution of the transaction is completed; and
determining a full-link execution process of the transaction based on the collected span information.

10. The non-transitory, computer-readable medium according to claim 9, wherein the locally recording span information corresponding to a span comprising the current execution stage comprises:
locally recording the span information corresponding to the span comprising the current execution stage when an execution granularity corresponding to the current execution stage is greater than an execution granularity threshold, wherein execution granularities are divided based on the transaction execution logic, and the span comprising each execution stage corresponds to one execution granularity.

11. The non-transitory, computer-readable medium according to claim 10, wherein the transaction comprises at least one structured query language (SQL), an execution plan of each SQL comprises at least one data flow object (DFO), and each DFO comprises at least one operation, and wherein execution granularities obtained through division comprise an SQL granularity, a DFO granularity, and an operator granularity.

12. The non-transitory, computer-readable medium according to claim 9, further comprising:
sampling each transaction to be executed in the distributed database; and
determining the sampled transaction as the transaction to be traced.

13. The non-transitory, computer-readable medium according to claim 9, wherein the determining a full-link execution process of the transaction based on the collected span information comprises:
arranging, in a time dimension based on a reference relationship between spans determined by the collected span information, execution stages corresponding to the span information to display the full-link execution process of the transaction.

14. The non-transitory, computer-readable medium according to claim 9, wherein the distributed database is communicatively connected to a proxy server, the proxy server is configured to forward a transaction request initiated by a driver deployed in a client device to the distributed database, and an execution process of each transaction respectively passes through the driver, the proxy server, and the distributed database.

15. The non-transitory, computer-readable medium according to claim 14, further comprising:
generating, at the driver, a corresponding trace ID for the transaction to be executed; and
sending, at the driver, locally generated span information comprising the trace ID to the proxy server, so that the proxy server records the span information in the proxy server.

16. The non-transitory, computer-readable medium according to claim 15, wherein the sending, at the driver, locally generated span information comprising the trace ID to the proxy server comprises:
sending, at the driver, the locally generated span information comprising the trace ID to the proxy server in a piggyback way.

17. A computer-implemented system for performing full-link tracing on a transaction in a distributed database, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining a current execution stage of a transaction to be traced, wherein the current execution stage comprises a current execution action in an execution process, wherein information transferred in the execution process comprises a trace ID of the transaction and span IDs, and wherein the span IDs correspond to spans of execution stages comprised in the execution process;
locally recording span information corresponding to a span comprising the current execution stage, wherein the span has a semantic meaning determined based on a transaction execution logic in the distributed database, and each piece of span information determines a reference relationship between a corresponding span and another span in the same transaction comprising the corresponding span;
collecting span information in the execution stages comprised in the transaction after execution of the transaction is completed; and
determining a full-link execution process of the transaction based on the collected span information.

18. The computer-implemented system according to claim 17, wherein the locally recording span information corresponding to a span comprising the current execution stage comprises:
locally recording the span information corresponding to the span comprising the current execution stage when an execution granularity corresponding to the current execution stage is greater than an execution granularity threshold, wherein execution granularities are divided based on the transaction execution logic, and the span comprising each execution stage corresponds to one execution granularity.
